(19) United States
(12) Patent Application Publication
(10) Pub. No.: US 2004/0199661 A1
(43) Pub. Date: Oct. 7, 2004

(54) System and method for the dynamic discovery of network destinations

(76) Inventor: Joseph Bert Murdock, Camas, WA (US)

Correspondence Address: LAW OFFICE OF GERALD MALISZEWSKI, P.O. BOX 270829, SAN DIEGO, CA, 92198-2829, US

(21) Appl. No.: 10/382,009

(22) Filed: Mar. 5, 2003

(51) Int. Cl. G06F 15/173

(52) U.S. Cl. 709/238

(57) ABSTRACT

A system and method are provided for dynamically discovering network destinations. The method comprises: accepting a digital document; identifying a user; determining a network-connected interface proximate to the user; sending the document to the proximate interface; and, in the event that a proximate interface cannot be located, sending the document to a default destination. Determining a network-connected interface proximate to the user includes one of the following options: using network discovery and advertisement protocols; checking a predetermined list of interfaces; using network-connected personnel locators; or, communicating with an intermediary destination to receive forwarding instructions. When a service name identification process is used, using network discovery and advertisement protocols includes: issuing a query for the user service name; and, receiving responses from network-connected interfaces logging the service name.

### BACKGROUND OF THE INVENTION

1. Field of the Invention

This invention generally relates to electronic document delivery and, more particularly, to a system and method of delivering electronic documents to dynamically discovered network-connected destinations.

2. Description of the Related Art

Many conventional scanners permit a user to scan a paper document, and send the resultant electronic document to a remote network-connected address or recipient. These systems require the recipient to provide a static network location, such as a network drop-box or email address to receive the scanned information. These systems further require the recipient to utilize a computer system to determine if the scanned information has been received and is available and, if so, to actively access the specified destination.

It would be advantageous if scanned documents and data could be delivered to a recipient in real-time, based upon the recipient's current location.

### SUMMARY OF THE INVENTION

The present invention provides a means for a network scan device to dynamically determine where the specified recipient is currently located and send either, or both:

a) Immediate and dynamic notification of information availability, allowing the recipient to retrieve the information. This notification can be sent to any form of accessible device, such as computers, Personal Digital Assistants, or televisions (via a set-top box).

b) Direct delivery of the scanned information can be made to any of a number of pre-determined scan locations (such as email addresses or file transfer sites) or display devices (such as conference room display units, etc.). The pre-determined scan locations can either be specified by the recipient, a matter of corporate/location policy, corporate/location defaults, or other methods, in any combination. Multiple simultaneous scan destinations are also possible.

This method differs from conventional systems in that the network scan device can dynamically determine the destination to deliver scanned information, rather than relying on a pre-defined, static list of scan destinations. This invention also differs from conventional data delivery mechanisms, such as the Microsoft Messenger user notification in that:

a) It utilizes the assistance of user agents to help determine user location;

b) Does not require that a user be currently logged into a location for that location to be used as a destination;

c) Allows for the use of default locations in the event a user or preferred location cannot be found; and,

d) Allows for the specification and use of overriding control and routing mechanisms for the determining delivery locations.

Accordingly, a method is provided for dynamically discovering network destinations. The method comprises: accepting a digital document; identifying a user; determining a network-connected interface proximate to the user; sending the document to the proximate interface; and, in the event that a proximate interface cannot be located, sending the document to a default destination. Determining a network-connected interface proximate to the user includes determining a proximate interface selected such as computer, web browser, personal digital assistant (PDA), television, or wireless telephones.

In some aspects of the method, determining a network-connected interface proximate to the user includes one of the following options: using network discovery and advertisement protocols; checking a predetermined list of interfaces; using network-connected personnel locators; or, communicating with an intermediary destination to receive forwarding instructions.

When a service name identification process is used, using network discovery and advertisement protocols includes: issuing a query for the user service name; and, receiving responses from network-connected interfaces logging the service name.

Alternately, checking a predetermined list of destinations includes: establishing a list of network-connected interfaces associated with the user; and, checking the list for an active interface by establishing user agents on the network-connected interfaces. The user agent monitors for activity such as logon, keyboard, mouse, and interface activity, and sends a reply in response to noting a recent activity.

Using a network-connected personnel locator includes: monitoring a field of network-connected locator devices; at least one locator device identifying the user; receiving a reply from the locator device; and, finding a network-connected interface proximate to the replying locator device.

Additional details of the above-described method and system for dynamically discovering network destinations are provided below.

### BRIEF DESCRIPTION OF THE DRAWINGS

FIG. 1 is a schematic block diagram illustrating the present invention system for dynamically discovering network destinations.

FIG. 2 is a schematic block diagram illustrating a variation of the present invention system for dynamically discovering network destinations.

FIG. 3 is third variation of the present invention system for dynamically discovering network destinations.

FIG. 4 is a fourth variation of the present invention system for dynamically discovering network destinations.

FIG. 5 is a diagram illustrating methods of destination location using service requests and user agent state information.

FIG. 6 is a flowchart illustrating the present invention method for dynamically discovering network destinations.

### DETAILED DESCRIPTION OF THE PREFERRED EMBODIMENTS

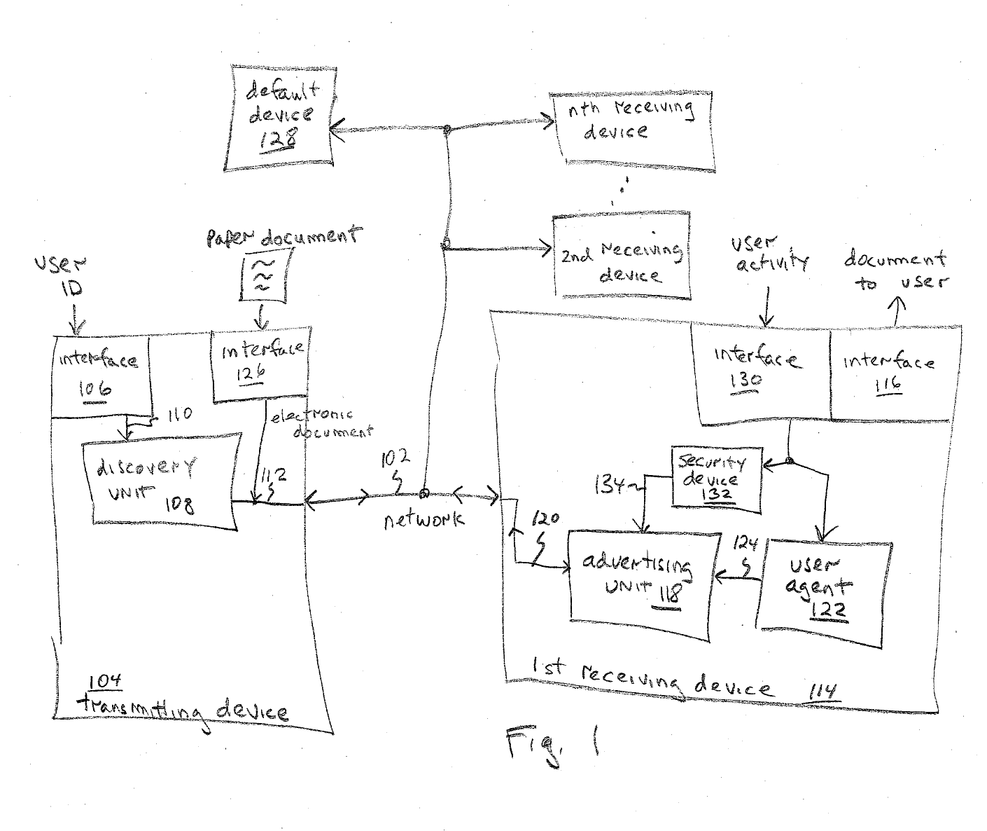

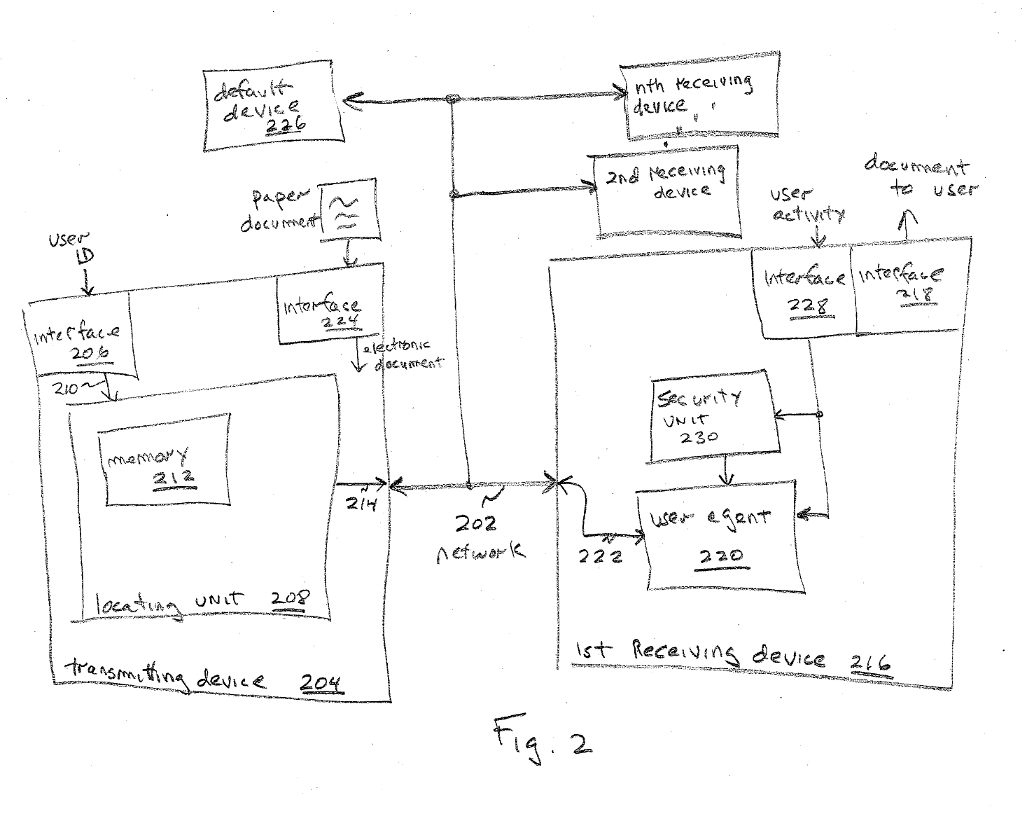

FIG. 1 is a schematic block diagram illustrating the present invention system for dynamically discovering network destinations. The system 100 comprises a network 102 and a transmitting device 104 having an interface 106 to accept a user identification (ID) and a network port connected to network 102. The network can be an Ethernet, Internet, Intranet, or proprietary network, for example. The transmitting device 104 includes a discovery unit 108 having an input on line 110 to accept the user identification. The discovery unit 108 translates the user identification into a service name and issues a service name query an output connected to the network port on line 112.

The system 100 includes at least one receiving device. Shown are receiving devices 1 through n, where n is not limited to any particular value. The receiving devices can be computers, web browsers, personal digital assistants (PDAs), televisions, or wireless telephones. Using the first receiving device 114 as an example, each receiving device has a network port connected to network 102 and an interface 116 to supply a received digital document to a user. For example, the interface 116 can be a printer to supply a paper document or data, a screen to supply an electronic version of the document, or a portable memory media. The receiving device 114 includes an advertising unit 118 connected to network port on line 120 to accept service name queries and to send answers in response to the service name queries. A user agent 122 has an output connected to the advertising unit on line 124 indicating when the queried user is proximate.

The transmitting device 104 sends a digital document to the receiving device 114, via the network 102, in response to receiving a service name query response from the receiving device 114. The digital document can be a photo, video, audio file, email, or a text document, to name a few possibilities. In some aspects of the system 100, the transmitting device 104 is a scanner, or is connected to a scanner, and has an interface 126 to accept paper documents for translation into a digital document.

Other aspects of the system 100 include a default (receiving) device 128 having a network port connected to the network 102 for accepting digital documents. The transmitting device 104 sends the document to the default device 128 if no service name query response is received from a receiving device.

Receiving device 114 also includes a user interface 130 such as a keyboard and/or mouse. The receiving device user agent 122 determines if the queried user is proximate in response to recent user interface 130 activity. For example, if the keyboard has been used within the last 5 minutes.

In other aspects of the system 100, the receiving device 114 includes a security unit 132 having an input to accept a unique user identifier. For this example, it is assumed that user identifier is input using interface 130. The security unit has an output on line 134 connected to the advertising unit 118 indicating validated user identities. Then, the advertising unit 118 answers a service query in response to the validated user identity. For example, the advertising unit 118 may not answer a service query unless the user first inputs a personal identification number. Alternately, the advertising unit 118 may answer to the service query, but either refuse to accept the document, or refuse to supply the document to the user until the user identifier is validated.

The transmitting device discovery unit 108 may make service name queries using a protocol such as service location protocol (SLP) or simple service discovery protocol (SSDP). Extensible markup language (XML) can also be used in the process. More specifically, XML is not a service name discovery/query protocol per se, but more of a means of describing a service name. It can be used as part of a discovery process as a means of describing the reply received by other discovery methods. That is, it can be the information returned in a reply. The present invention system is not limited to any particular protocol.

In other aspects, the transmitting device discovery unit 108 transmits an acceptance option. The receiving device user interface 116 supplies the option request to the user, prompting the user to select an option such as: accepting the document, sending the document to a different user, or sending the document to a different receiving device. Then, the receiving device advertising unit 118 sends the selected user option to the transmitting device discovery unit 108.

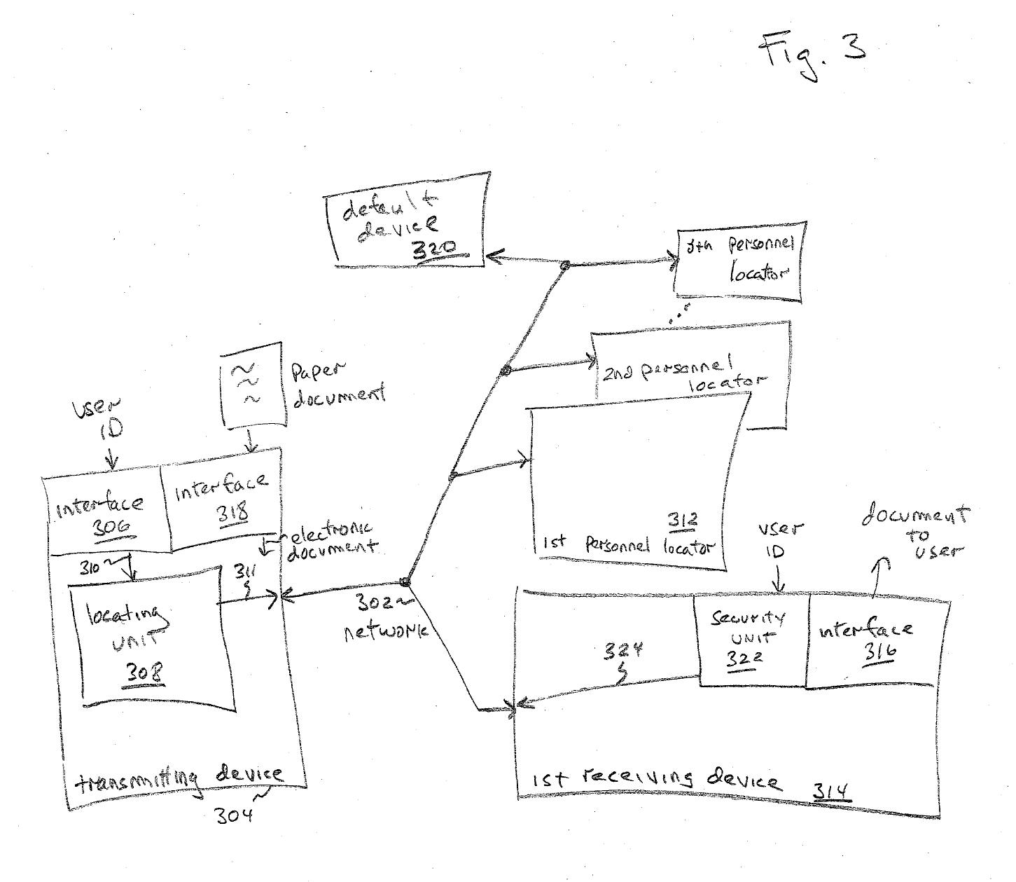

FIG. 2 is a schematic block diagram illustrating a variation of the present invention system for dynamically discovering network destinations. The system 200 comprises a network 202 and transmitting device 204. The transmitting device 204 has an interface 206 to accept a user identification and a network port connected to the network 202. The transmitting device 204 includes a locating unit 208. The locating unit 208 has an input on line 210 to accept the user identification and a memory 212. The memory 212 includes a list of receiving devices associated with the user. The locating unit 208 has an output on line 214 connected to the network port to issue a query to the listed devices.

The system includes at least one receiving device. Again, receiving devices 1 through n are shown, and the first receiving device 216 exemplifies the other receiving devices. The receiving devices can be computers, web browsers, personal digital assistants (PDAs), televisions, or wireless telephones. First receiving device 216 has a network port connected to network 202 and an interface 218 to supply a received digital document to a user. The receiving device 216 includes a user agent 220 connected to the network port on line 222 to accept queries and to supply responses to the transmitting device locating unit 208 when the queried user is proximate. The transmitting device 204 sends a digital document to the receiving device 216 in response to receiving a query response from the receiving device user agent 220. The digital document can be a photo, video, audio file, email, or text document.

As in FIG. 1, the transmitting device 204 may be a scanner having an interface 224 to accept paper documents for translation into a digital document. Also as above, the system 200 may comprise a default (receiving) device 226 having a network port connected to network 202 for accepting digital documents. The transmitting device 204 may, in some aspects of the system 200, send the document to the default device 226 if no query response is received from a listed receiving device.

In some aspects, the receiving device 216 includes a user interface 228 such as a keyboard or mouse. The receiving device user agent 220 determines if the queried user is proximate in response to recent user interface 228 activity. As in FIG. 1, the receiving device 216 may include a security unit 230 having an input to accept a unique user identifier and an output connected to the user agent 220 indicating validated user identities. Again, it is assumed that the user identity can be entered via interface 228. The user agent 220 answers a query, or accepts the document, in response to the validated user identity.

In some aspects of the system 200, the transmitting device locating unit 208 transmits an acceptance option. The receiving device user interface 218 supplies the option request to the user, prompting the user to select an option such as: accepting the document, sending the document to a different user, or sending the document to a different receiving device. Then, the receiving device user agent 220 sends the selected user option to the transmitting device locating unit 208.

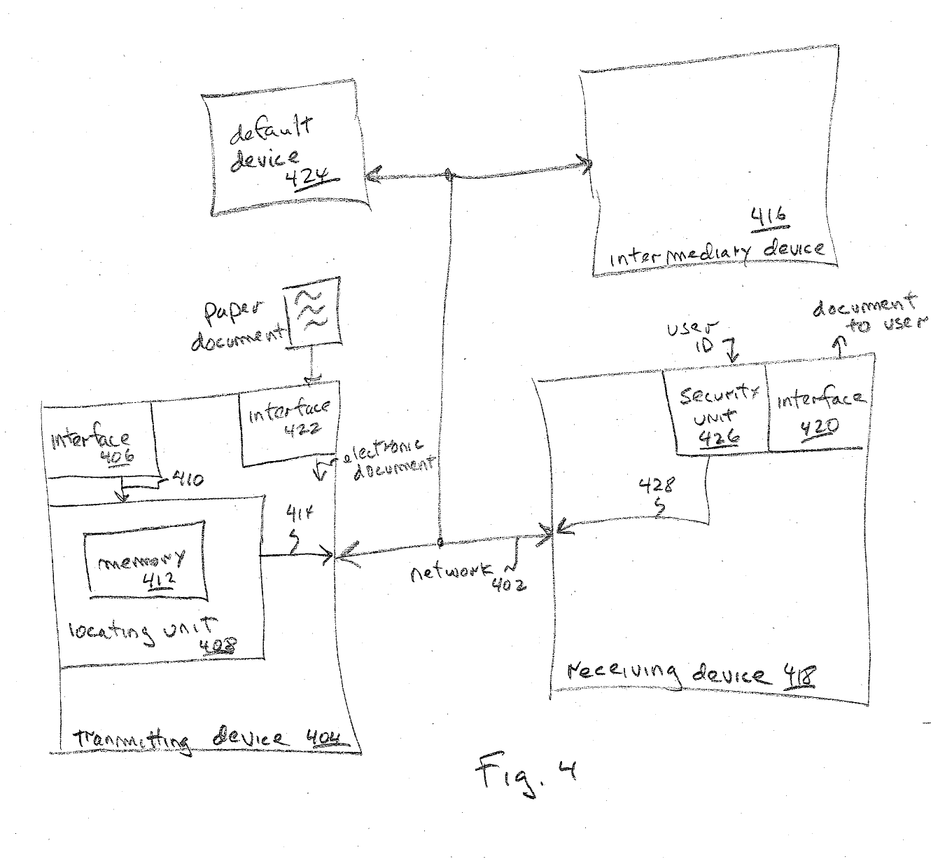

FIG. 3 is third variation of the present invention system for dynamically discovering network destinations. The system 300 comprises a network 302 and a transmitting device 304. The transmitting device 304 has an interface 306 to accept a user identification and a network port connected to the network 302. The transmitting device 304 includes a locating unit 308 having an input on line 310 to accept the user identification and an output on line 311 connected to the network port to issue a user location query.

The system 300 includes at least one personnel locator. The personnel locators can be biological scanners that identify fingerprints or retinas for example. Typically, such scanners are used for other purposes, such as to admit a person to a classified area. However, the fact that a person has been granted access to a secure area can be used as an implication that the person is located in the secure area. A personnel locator can also be a magnetic card reader or wireless proximity badge detector. Further, a user can be located by accessing an electronic schedule that states when and where a user is scheduled to be. Finally, the locating unit 308 may send a query to an intermediary, such as a secretary, that seeks the user's location.

Shown are personnel locators 1 through j, where j can be any value. The first personnel locator 312 is used as an example and represents the other personnel locators in the system. The first personnel locator 312 has a network port connected to the network 302 to accept the user location queries and to supply query answers in response to detecting the user.

The system also includes at least one receiving device, for example, first receiving device 314, proximate to the personnel locator responding to the query. That is, the first receiving device 314 is proximate to the first personnel locator 312. Note that other receiving devices (not shown) may be proximate to other personnel locators in the system 300. Further, the first personnel locator 312 may be proximate to a plurality of receiving devices (not shown). The receiving device may be a computer, web browser, personal digital assistant (PDA), television, or wireless telephone. As above, the receiving device 314 has a network port connected to network 302 and an interface 316 to supply a received digital document to a user.

The transmitting device 304 sends a digital document to the receiving device 314 in response to receiving a query answer from the proximate personnel locator 312. The digital document can be a photo, video, audio file, email, or text document.

As above, the transmitting device 304 may be a scanner having an interface 318 to accept paper documents for translation into a digital document. The system 300 may include a default (receiving) device 320 having a network port connected to network 302 for accepting digital documents. Then, the transmitting device 304 is able to send the document to the default device 320 if no query answer is received from a personnel locator.

In some aspects of the system 300, the receiving device 314 includes a security unit 322 having an input to accept a unique user identifier and an output on line 324 connected to the network port to supply validated user identities to the transmitting device location unit.

In some aspects of the system 300, the transmitting device locating unit 308 transmits an acceptance option to the proximate receiving device 314. The proximate receiving device user interface 316 supplies the option request to the user, prompting the user to select an option such as: accepting the document, sending the document to a different user, or sending the document to a different receiving device. Then, the receiving device 314 sends the selected user option to the transmitting device locating unit 308.

FIG. 4 is a fourth variation of the present invention system for dynamically discovering network destinations. The system 400 comprises a network 402 and a transmitting device 404. The transmitting device 404 has an interface 406 to accept a user identification and a network port connected to the network 402. The transmitting device 404 includes a locating unit 408. The locating unit 408 has an input on line 410 to accept the user identification, a memory 412 including a list of intermediary receiving devices associated with the user, and an output connected to the network port on line 414 to issue a query to the listed intermediary devices.

The system 400 includes at least one intermediary device 416 having a network port connected to network 404 to accept queries and to supply user destinations in response to the queries. As above, the system 400 further comprises a receiving device 418. The receiving device can be a computer, web browser, personal digital assistant (PDA), television, or wireless telephone. Although only a single receiving device and single intermediary device are shown, it is understood that the system 400 may include a plurality of such devices. The receiving device 418 has a network port connected to the network 402 and a user interface 420 to supply received documents to a user.

The transmitting device 404 sends a digital document to the receiving device 418 in response to receiving a user destination from the intermediary device 416. The digital document can be a photo, video, audio file, email, or text document.

As above, the transmitting device 404 may be a scanner having an interface 422 to accept paper documents for translation into a digital document. Also as above, the system 400 may comprise a default device 424 having a network port connected to the network 402 for accepting digital documents. The transmitting device 404 sends the document to the default device 424 if no user destination is received from the intermediary device 416.

In some aspects of the system 400, the receiving device 418 includes a security unit 426 having an input to accept a unique user identifier and an output on line 428 connected to the network port to supply validated user identities. The transmitting device 404 sends the document in response to receiving the validated user identity.

In some aspects of the system 400, the transmitting device locating unit 408 transmits an acceptance option to the receiving device 418. The receiving device user interface 420 supplies the option request to the user, prompting the user to select an option such as: accepting the document, sending the document to a different user, or sending the document to a different receiving device. The receiving device. 418 sends the selected user option to the transmitting device locating unit 408.

### Functional Description

A network scan device is a device that is capable of scanning documents and delivering the scanned information via a network connection to a scan destination. This invention provides a means for a person to utilize a network scan device to send scan information to their selves or another person, based on where the recipient is currently located, not to a static, predetermined network destination. For example, if the recipient is in a meeting, they might like to have any necessary scanned information sent to a destination based on their current location, such as their laptop system, or a conference room display device, rather than to their normal desktop system or email address.

For example, a conventional scan destination model permits a person to register a scan destination based on a physical machine or email address, rather than a human entity. Multiple scan destinations can be created for that person, but they are listed as different profiles and names. When someone needs to scan information to that person, they need to determine which of the multiple destinations to use (assuming there are multiple destinations) and risk sending urgent data to a location where it will not be accessed. The present invention permits scan destinations and profiles to become associated with a user, rather than a specific machine or email address, allowing scanned information to be delivered to the required person, regardless of the location. The network scan device finds the current active location of the person, determines the closest scan destination, and sends the scan. Multiple simultaneous destinations may also be used. The destination may be anything from the desktop or laptop system the user is currently using, a display device located in the conference room where the person is in a meeting, a television set in the person's home, or the display on a wireless PDA.

This system encompasses the following components:

1) network scan destinations, and any scan profile data describing these destinations, are considered to be, and treated as, network services. As such it is required that:

a. Scan destinations and profiles are advertised as services, using any of several available service discovery and advertisement protocols. Depending on the protocols used, this requires the installation, configuration, and use of any necessary protocol clients. To facilitate association of scan destinations and profiles with a user, user identification information is incorporated in the service name.

b. A network scan device can, using the same service discovery protocols as (a), dynamically discover all scan destination and profile services for the desired user.

c. A common definition of the scan destination and profile service descriptions must be provided. This description can be accomplished by many means, such as SLP service template or an XML schema definition.

2) In lieu of, or in addition to, (1), allow a user to specify multiple network scan destinations. These destinations include multiple system names/network addresses (such as a desktop computer, a laptop, an interactive display unit is a conference room, or a PDA)

3) Provide one or more mechanisms for determining which of several scan destinations, as obtained via (1) or (2), are the currently active destination. Generally, the currently active destination is the one nearest where the desired recipient is physically located at the time of delivery. Note that there is no implied limit to the number of simultaneously active destinations.

4) Provide the concept of a default, fall-through, scan destination. This default destination is necessary to provide guaranteed delivery, and is used in the event that none of the destinations specified in (1) or (2) are available. The default destination would normally be an email address or other file transfer location (such as a corporate FTP server).

5) All possible scan destinations and profile providers have some form of inter-communications capability. This would normally be some implementation of Internet Protocols (IP) over some network medium such as Ethernet or wireless networking although other protocols and connection capabilities may be used.

6) A small software application (heretofore referred to as user agent) is installed on each destination device or system. This user agent must be capable of

a. Receiving destination request queries from a scanning device, and sending destination request responses, based on (b) below) back to the device.

b. Determining if the device containing the user agent is to receive scan data. This requires that the user agent:

i. Be capable of dynamically obtaining acceptance information from a user by

1. Prompting the specified user, by whatever means is available on the device (such as a graphical prompt on a display screen).

2. Receiving input from the specified user, by whatever means is available on the device. It is only necessary for the user agent to accept a simple yes/no type of response

ii. Maintain an acceptance state. This acceptance state is simply a Boolean value that attempts to indicate whether a specified user is actively using the device. Various heuristic means may be employed to determine the acceptance state, including a simple log in/log out mechanism, tracking time since last input from keyboard or mouse, or hooking into an existing energy saver timeout mechanism.

c. Receiving and storing scan information from the network scan device.

Obtaining a list of possible scan destinations and determining which of these destinations is the correct current destination may be accomplished by any of several methods, including, but not limited to:

1) Destination Service Query

The originating scan device will issue a service query to discover which scan destinations are available and currently active. The actual mechanisms used are dependent on the specific service discovery protocol being used, but the general process would be:

a. Issue a query for the service name associated with the destination user (i.e. “service:scanner.sharp.destination.johndoe”). This query should return responses from the currently active scan destinations for the specified user. Note that having only the currently active destinations respond may be a deviation from normal discovery protocol behavior. If strict compliance to the discovery protocol requires that all services respond to a service query, addition queries for service attribute and/or status information may be necessary.

b. Data transfer commences.

2) Direct Device Query

Direct Device Query requires that a previously defined list of possible scan destinations exists. This list can be created in a number of ways, including manual entry of destinations by the user, referencing a master list of destinations, or through a scan service discovery method similar to (1) above. Given such a list, the originating scan device, in conjunction with the user agent installed on each possible destination device, sequentially queries each possible destination device, requesting permission to transfer data. If the user agent determines that this is the currently active destination, an acceptance notification to the requesting scan device, and data transfer will commence, otherwise the user agent sends a response to the requesting scanning device indicating that this device cannot accept the data, and the scanning device proceeds to query the next destination in it's list.

3) Physical Personnel Location

The originating scan device can utilize other available services that enable the location of the destination user, and the location of a suitable display device. An example of this would be the utilization of intelligent personnel ID cards or other access/personnel tracking system (such as electronic door locks). The scanner, utilizing the appropriate protocols to interface with the tracking system, determines the physical location of the requested user. Once the physical location is known, the location of a suitable display device (such as a conference room display) can be determined, and the scanned data sent to that display.

4) Intermediate Manual Location

This simple method utilizes the service of an intermediary (such as a receptionist or secretary) to manually provide current location information.

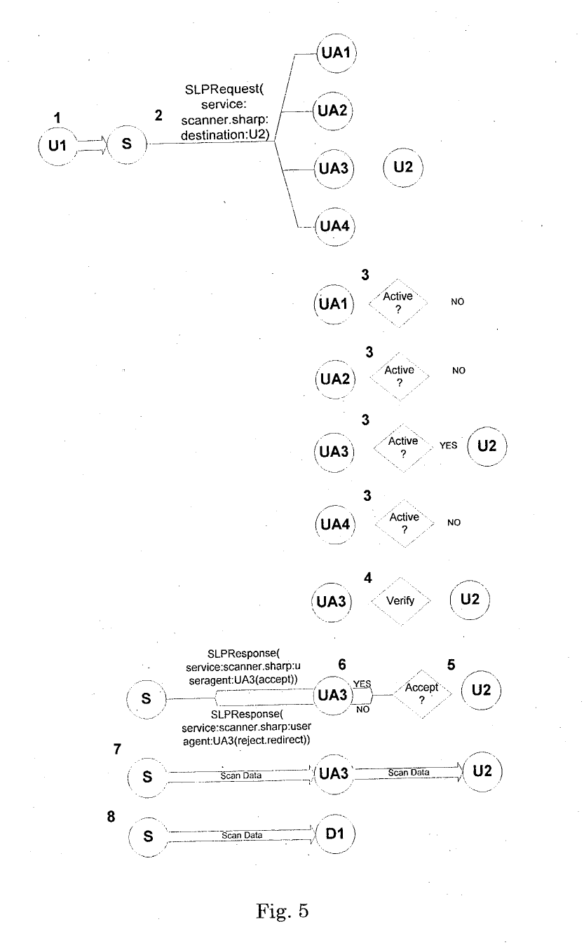

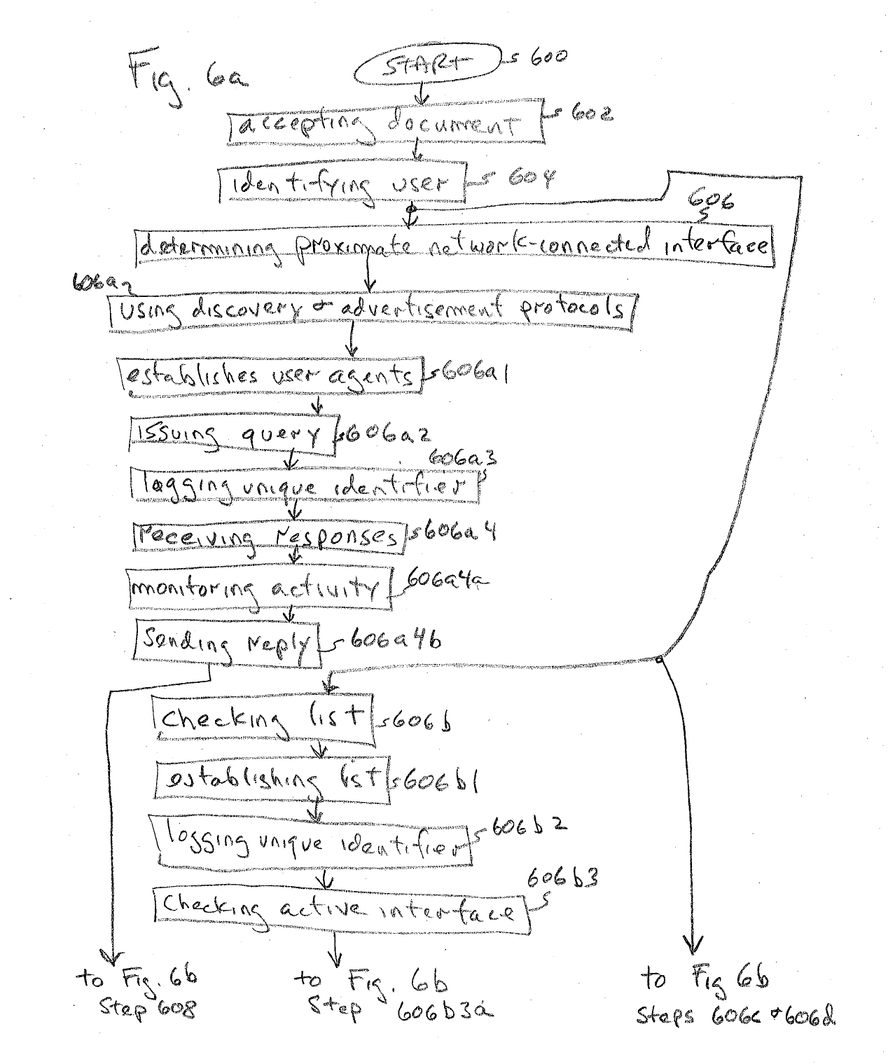

FIG. 5 is a diagram illustrating methods of destination location using service requests and user agent state information. Note that while FIG. 5 uses the Service Location Protocol (SLP) to find active user agents, other discovery protocols, such as the Simple Service Discovery Protocol (SSDP) can also be used. The steps shown in FIG. 5 can be described as follows:

1) User U1 initiates a scan from Scanner S1, and instructs Scanner S1 to send the scan to User U2.

2) Scanner S1 sends a multicast SLP service request, looking for the currently active user agent for User U2 (service:scanner.sharp.destination.U2).

3) All user agents for User U2 (UA2a-UA2c) receive the service request and check on their current state (active or inactive). Several methods may be utilized to determine this, including:

a) User Activity Monitoring

The user agent, utilizing methods similar to those used by screen saver and online chat programs, monitors the activity state of the device within which it is executing. By monitoring such items as keyboard and mouse activity, it can reasonably be determined if a user is currently using the device. If it is determined that the device is in use, the user agent assumes that it is the active device. In order to prevent unauthorized reception of scan information, this method may be used in conjunction with available user identification information supplied and maintained by the underlying operating system, such as current user ID or other security code. This method may also require the user to manually log into the user agent to provide authentication and identification information.

b) Direct User Query

The user agent, upon receipt of a destination query, presents a prompt to the user, requesting acceptance of the scanned data. To prevent unauthorized scans, user authentication should be required. If the correct user responds to the prompt, it is assumed that this is the proper scan destination. If the user has not responded to the query within a pre-configure amount of time, it is assumed that the user is not located at the device.

4) Those user agents for U2 that have a state indicating that they are active initiate a user verification process to both verify that they really are actively in use by User U2, and that the active user who claims to be User U2 really is User U2.

5) User U2, having been verified, determines if the scan is to be received at the current device. If not, the scan can be redirected by User U2 to another destination, or simply rejected.

6) User Agent UA3 sends notification back to Scanner S1, indicating what to do with the scan.

7) If User U2 has decided to accept the scan the scan data is sent to User Agent UA3.

If User U2 has rejected the scan, the scanner sends the scan to the first available default scan location (D1), as indicated by User U2's static configuration data.

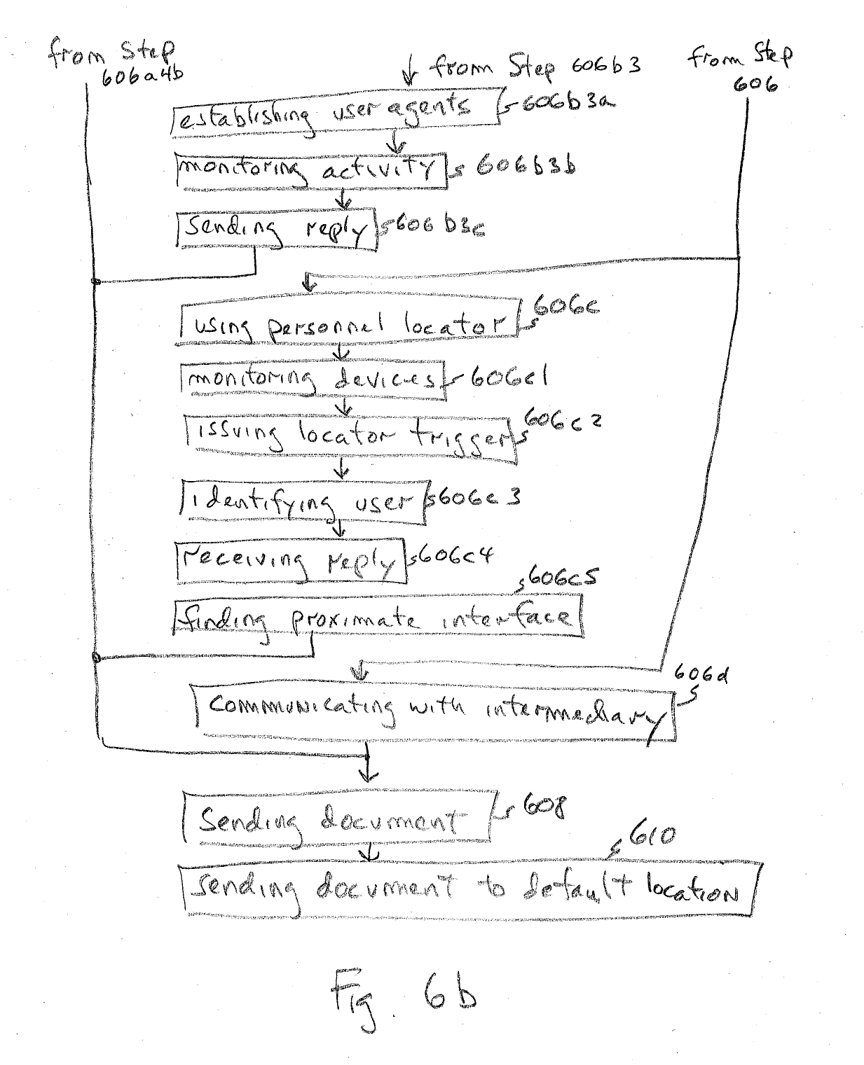

FIG. 6 is a flowchart illustrating the present invention method for dynamically discovering network destinations. Although the method is depicted as a sequence of numbered steps for clarity, no order should be inferred from the numbering unless explicitly stated. It should be understood that some of these steps may be skipped, performed in parallel, or performed without the requirement of maintaining a strict order of sequence. The method starts at Step 600.

Step 602 accepts a digital document. In some aspects of the method, accepting a digital document includes scanning a paper document. Step 604 identifies a user. Step 606 determines a network-connected interface proximate to the user. Step 608 sends the document to the proximate interface. Step 610, in the event that a proximate interface cannot be located, sends the document to a default destination.

Determining a network-connected interface proximate to the user in Step 606 includes four substep options. Step 606a uses network discovery and advertisement protocols. Step 606b checks a predetermined list of interfaces. Step 606c uses network-connected personnel locators. Step 606d communicates with an intermediary destination to receive forwarding instructions.

In some aspects, using network discovery and advertisement protocols in Step 606a includes using a protocol such as service location protocol (SLP) or simple service discovery protocol (SSDP). In other aspects, identifying a user in Step 604 includes identifying a service name associated with the user. Then, Step 606a, of using network discovery and advertisement protocols includes substeps. Step 606a2 issues a query for the user service name. Step 606a4 receives responses from network-connected interfaces logging the service name.

In some aspects, Step 606a1 establishes user agents on the network-connected interfaces. Then, receiving responses from network-connected interfaces logging the service name in Step 606a4 includes substeps. In Step 606a4a the user agent monitors for activity such as logon, keyboard, mouse, or other interface activity. In Step 606a4b the user agent sends a reply in response to noting a recent activity. In some aspects, the user agent does not literally send a reply in response to user activity. For example, if waiting for user activity causes an unreasonable delay in replying to a destination query. Rather, the agent may monitor for user activity, and use the presence of user activity to maintain a state condition indicating that a user is present and that the user agent is active. This state condition can, of necessity, time out and revert to a non-active state in the absence of continuing user input or other presence detection means. This state condition can be used to determine if a reply is sent or not. If an active service reply is incorrectly sent, for example if the user leaves sometime before the timeout time occurs, it can be corrected when the user is queried as to what to do with the scanned information. If a user is not present to accept the scan, the scan is not sent. This scenario also implies that multiple acceptance requests can be sent to multiple possible active destinations. Then, the user will typically only accept the scan at a single destination.

In other aspects, in Step 606a3, the user logs onto the interface using a unique identifier. Then, receiving responses from network-connected interfaces logging the service name in Step 606a4 includes the user agent checking the user identifier.

Checking a predetermined list of destinations in Step 606b includes substeps. Step 606b1 establishes a list of network-connected interfaces associated with the user. Step 606b3 checks the list for an active interface. In other aspects, checking the list for an active interface in Step 606b3 includes substeps. Step 606b3a establishes user agents on the network-connected interfaces. In Step 606b3b the user agent monitors for activity such as logon, keyboard, mouse, and interface activity. In Step 606b3c the user agent sends a reply in response to noting a recent activity.

In other aspects, in Step 606b2, the user logs onto the interface using a unique identifier. Then, the user agent monitoring for activity in Step 606b3b includes the user agent checking the user identifier.

Using a network-connected personnel locator in Step 606c includes substeps. Step 606c1 monitors a field of network-connected locator devices. In Step 606c3 at least one locator device identifies the user. Step 606c4 receives a reply from the locator device. Step 606c5 finds a network-connected interface proximate to the replying locator device.

In some aspects, Step 606c2 issues the user a locator device trigger. For example, a magnetic card reader can be issued to code associated with a user's magnetic card strip. Then, at least one locator device identifying the user in Step 606c3 includes the locator device detecting the trigger. Alternately, in Step 606c2 the user establishes a library of biological identifying data. Then, at least one locator device identifying the user in Step 606c3 includes the locator device identifying the user in response to accepting user biological data.

Alternately, finding a network-connected interface proximate to the replying locator device in Step 606c5 includes the user logging onto the proximate interface with a unique identifier. Then, sending the document to the proximate interface in Step 608 includes sending the document in response to the user identifier being logged.

Determining a network-connected interface proximate to the user in Step 606 includes determining proximate interfaces such as computers, web browsers, personal digital assistants (PDAs), televisions, and wireless telephones. Accepting a digital document in Step 602 includes accepting digital document such as a photo, a video, an audio file, an email, or a text document.

In some aspects, identifying a user in Step 604 includes identifying a first user. Then, sending the document to the proximate interface in Step 608 includes substeps (not shown). In Step 608a the first user receives notification of a document to be sent via the proximate interface. In Step 608b the first user redirects the document to a destination selected from the group including a second user and a network-connected interface.

A system and method have been provided for directing electronic documents to network-connected locations proximate to an identified user. Some examples have been given for determining proximity. However, the invention is not limited to merely these examples. Other variations and embodiments of the invention will occur to those skilled in the art.

We claim:

1. A method for dynamically discovering network destinations, the method comprising:
accepting a digital document;
identifying a user;
determining a network-connected interface proximate to the user; and,
sending the document to the proximate interface.

2. The method of claim 1 wherein accepting a digital document includes scanning a paper document.

3. The method of claim 1 wherein determining a network-connected interface proximate to the user includes:
using network discovery and advertisement protocols;
checking a predetermined list of interfaces;
using network-connected personnel locators; and,
communicating with an intermediary destination to receive forwarding instructions.

4. The method of claim 3 further comprising:
in the event that a proximate interface cannot be located, sending the document to a default destination.

5. The method of claim 3 wherein identifying a user includes identifying a service name associated with the user; and,
wherein using network discovery and advertisement protocols includes:
issuing a query for the user service name; and,
receiving responses from network-connected interfaces logging the service name.

6. The method of claim 5 further comprising:
establishing user agents on the network-connected interfaces; and,
wherein receiving responses from network-connected interfaces logging the service name includes:
the user agent monitoring for activity selected from the group including logon, keyboard, mouse, and interface activity; and,
the user agent sending a reply in response to noting a recent activity.

7. The method of claim 6 further comprising:
the user logging onto the interface using a unique identifier; and,
wherein receiving responses from network-connected interfaces logging the service name includes the user agent checking the user identifier.

8. The method of claim 5 wherein using network discovery and advertisement protocols includes using a protocol selected from the group including service location protocol (SLP) and simple service discovery protocol (SSDP).

9. The method of claim 3 wherein checking a predetermined list of destinations includes:
establishing a list of network-connected interfaces associated with the user; and,
checking the list for an active interface.

10. The method of claim 9 wherein checking the list for an active interface includes:
establishing user agents on the network-connected interfaces;
the user agent monitoring for activity selected from the group including logon, keyboard, mouse, and interface activity; and,
the user agent sending a reply in response to noting a recent activity.

11. The method of claim 10 further comprising:
the user logging onto the interface using a unique identifier; and,
wherein the user agent monitoring for activity includes the user agent checking the user identifier.

12. The method of claim 3 wherein using a network-connected personnel locator includes:
monitoring a field of network-connected locator devices;
at least one locator device identifying the user;
receiving a reply from the locator device; and,
finding a network-connected interface proximate to the replying locator device.

13. The method of claim 12 further comprising:
issuing the user a locator device trigger; and,
wherein at least one locator device identifying the user includes the locator device detecting the trigger.

14. The method of claim 12 further comprising:
the user establishing a library of biological identifying data; and,
wherein at least one locator device identifying the user includes the locator device identifying the user in response to accepting user biological data.

15. The method of claim 12 wherein finding a network-connected interface proximate to the replying locator device includes the user logging onto the proximate interface with a unique identifier; and,
wherein sending the document to the proximate interface includes sending the document in response to the user identifier being logged.

16. The method of claim 3 wherein determining a network-connected interface proximate to the user includes determining a proximate interface selected from the group including computers, web browsers, personal digital assistants (PDAs), televisions, and wireless telephones.

17. The method of claim 3 wherein accepting a digital document includes accepting digital document selected from the group including a photo, a video, an audio file, an email, and a text document.

18. The method of claim 1 wherein identifying a user includes identifying a first user;
wherein sending the document to the proximate interface includes:
the first user receiving notification of a document to be sent via the proximate interface; and,
the first user redirecting the document to a destination selected from the group including a second user and a network-connected interface.

19. A system for dynamically discovering network destinations, the system comprising:
a network;
a transmitting device having an interface to accept a user identification and a network port, the transmitting device including a discovery unit having an input to accept the user identification for translation into a service name and an output connected to the network port to issue a service name query;
at least one receiving device having a network port and an interface to supply a received digital document to a user, the receiving device including:
an advertising unit connected to network port to accept service name queries and to send answers in response to the service name queries;
a user agent having an output connected to the advertising unit indicating when the queried user is proximate.

20. The system of claim 19 wherein the transmitting device sends a digital document to the receiving device in response to receiving a service name query response from the receiving device.

21. The system of claim 20 wherein the transmitting device is a scanner having an interface to accept paper documents for translation into a digital document.

22. The system of claim 21 further comprising:
a default device having a network port for accepting digital documents; and,
wherein the transmitting device sends the document to the default device if no service name query response is received.

23. The system of claim 21 wherein the receiving device includes a user interface selected from the group including a keyboard and mouse; and,
wherein the receiving device user agent determines if the queried user is proximate in response to recent user interface activity.

24. The system of claim 21 wherein the receiving device includes a security unit having an input to accept a unique user identifier and an output connected to the advertising unit indicating validated user identities; and,
wherein the advertising unit answers a service query in response to the validated user identity.

25. The system of claim 21 wherein the transmitting device discovery unit makes service name queries using a protocol selected from the group including service location protocol (SLP) and simple service discovery protocol (SSDP).

26. The system of claim 21 wherein the receiving device is selected from the group including computers, web browsers, personal digital assistants (PDAs), televisions, and wireless telephones.

27. The system of claim 21 wherein the transmitting device supplies a digital document selected from the group including a photo, a video, an audio file, an email, and a text document.

28. The system of claim 21 wherein the transmitting device discovery unit transmits an acceptance option; and,
wherein the receiving device user interface supplies the option request to the user, prompting the user to select an option from the group including accepting the document, sending the document to a different user, and sending the document to a different receiving device; and,
wherein the receiving device advertising unit sends the selected user option to the transmitting device discovery unit.

29. A system for dynamically discovering network destinations, the system comprising:
a network;
a transmitting device having an interface to accept a user identification and a network port, the transmitting device including a locating unit having an input to accept the user identification, a memory including a list of receiving devices associated with the user, and an output connected to the network port to issue a query to the listed devices;
at least one receiving device having-a network port and an interface to supply a received digital document to a user, the receiving device including a user agent connected to the network port to accept queries and to supply responses to the transmitting device locating unit when the queried user is proximate.

30. The system of claim 29 wherein the transmitting device sends a digital document to the receiving device in response to receiving a query response from the receiving device user agent.

31. The system of claim 30 wherein the transmitting device is a scanner having an interface to accept paper documents for translation into a digital document.

32. The system of claim 31 further comprising:
a default device having a network port for accepting digital documents; and,
wherein the transmitting device sends the document to the default device if no query response is received from a listed receiving device.

33. The system of claim 31 wherein the receiving device includes a user interface selected from the group including a keyboard and mouse; and,
wherein the receiving device user agent determines if the queried user is proximate in response to recent user interface activity.

34. The system of claim 31 wherein the receiving device includes a security unit having an input to accept a unique user identifier and an output connected to the user agent indicating validated user identities; and,
wherein the user agent answers a query in response to the validated user identity.

35. The system of claim 31 wherein the receiving device is selected from the group including computers, web browsers, personal digital assistants (PDAs), televisions, and wireless telephones.

36. The system of claim 31 wherein the transmitting device supplies a digital document selected from the group including a photo, a video, an audio file, an email, and a text document.

37. The system of claim 31 wherein the transmitting device locating unit transmits an acceptance option;
wherein the receiving device user interface supplies the option request to the user, prompting the user to select an option from the group including accepting the document, sending the document to a different user, and sending the document to a different receiving device; and,
wherein the receiving device user agent sends the selected user option to the transmitting device locating unit.

38. A system for dynamically discovering network destinations, the system comprising:
a network;
a transmitting device having an interface to accept a user identification and a network port, the transmitting device including a locating unit having an input to accept the user identification and an output connected to the network port to issue a user location query;
at least one personnel locator having a network port to accept the user location queries and to supply query answers in response to detecting the user; and,
at least one receiving device, proximate the personnel locator responding to the query, having a network port and an interface to supply a received digital document to a user.

39. The system of claim 38 wherein the transmitting device sends a digital document to the receiving device in response to receiving a query answer from the proximate personnel locator.

40. The system of claim 39 wherein the transmitting device is a scanner having an interface to accept paper documents for translation into a digital document.

41. The system of claim 40 further comprising:
a default device having a network port for accepting digital documents; and,
wherein the transmitting device sends the document to the default device if no query answer is received from a personnel locator.

42. The system of claim 40 wherein the receiving device includes a security unit having an input to accept a unique user identifier and an output connected to the network port to supply validated user identities to the transmitting device location unit.

43. The system of claim 40 wherein the receiving device is selected from the group including computers, web browsers, personal digital assistants (PDAs), televisions, and wireless telephones.

44. The system of claim 40 wherein the transmitting device supplies a digital document selected from the group including a photo, a video, an audio file, an email, and a text document.

45. The system of claim 40 wherein the transmitting device locating unit transmits an acceptance option to the proximate receiving device;
wherein the proximate receiving device user interface supplies the option request to the user, prompting the user to select an option from the group including accepting the document, sending the document to a different user, and sending the document to a different receiving device; and,
wherein the receiving device sends the selected user option to the transmitting device locating unit.

46. The system of claim 38 wherein the personnel locator is a device selected from the group including biological scanners, magnetic card readers, wireless proximity badge detectors, electronic schedules, or a queried intermediary.

47. A system for dynamically discovering network destinations, the system comprising:
a network;
a transmitting device having an interface to accept a user identification and a network port, the transmitting device including a locating unit having an input to accept the user identification, a memory including a list of intermediary receiving devices associated with the user, and an output connected to the network port to issue a query to the listed intermediary devices; and,
an intermediary device having a network port to accept queries and to supply user destinations in response to the queries.

48. The system of claim 47 further comprising:
a receiving device having a network port and a user interface to supply received documents to an user; and,
wherein the transmitting device sends a digital document to the receiving device in response to receiving a user destination from the intermediary device.

49. The system of claim 48 wherein the transmitting device is a scanner having an interface to accept paper documents for translation into a digital document.

50. The system of claim 49 further comprising:
a default device having a network port for accepting digital documents; and,
wherein the transmitting device sends the document to the default device if no user destination is received from the intermediary device.

51. The system of claim 49 wherein the receiving device includes a security unit having an input to accept a unique user identifier and an output connected to the network port to supply validated user identities; and,
wherein the transmitting device sends the document in response to receiving the validated user identity.

52. The system of claim 49 wherein the receiving device is selected from the group including computers, web browsers, personal digital assistants (PDAs), televisions, and wireless telephones.

53. The system of claim 49 wherein the transmitting device supplies a digital document selected from the group including a photo, a video, an audio file, an email, and a text document.

54. The system of claim 49 wherein the transmitting device locating unit transmits an acceptance option to the receiving device;
wherein the receiving device user interface supplies the option request to the user, prompting the user to select an option from the group including accepting the document, sending the document to a different user, and sending the document to a different receiving device, and wherein the receiving device sends the selected user option to the transmitting device locating unit.
